(19) United States
(12) Patent Application Publication
(10) Pub. No.: US 2013/0029297 A1
(43) Pub. Date: Jan. 31, 2013

(54) Haptic graphic computer for blind people

(71) Applicant: Yu Jie Tsai, Sugar Land, TX (US)

(72) Inventor: Yu Jie Tsai, Sugar Land, TX (US)

(21) Appl. No.: 13/136,202

(22) Filed: Jul. 25, 2011

(51) Int. Cl. G09B 21/00

(52) U.S. Cl. 434/114

(57) ABSTRACT

A haptic panel computer of portable type includes a computer module, a digit and symbol decoding circuit, a graphic decoding circuit, and a haptic displaying device, the computer module is connected to other devices for controlling them. The haptic displaying device includes an array of guiding tubes and sliding or movable members arranged in a matrix, and the movable members are selectively extendible in or out of the guiding tubes with an electromagnetic device for forming various patterns, graphs, or digits and for Braille reading or listening by the blind people. A text file is imported to the computer through input/output device from the World Wide Web or a memory device, and the texts are transformed to Braille texts which are displayed in the lower portion of the screen by digit and symbol decoding circuit and some particular texts in the paragraph are displayed with haptic graphs in the upper portion of the screen through the graphic decoding circuit picking up pre-built graph database. The haptic graphic computer of portable type includes an improved and simplified structure to be easily and quickly manufactured and assembled and to be easily and suitably operated by the blind people.

### BACKGROUND OF THE INVENTION

1. Field of the Invention

The present invention relates to a haptic graphic computer or portable pad, and more particularly to a haptic graphic computer or portable pad including a screen and operating hot keys having an improved and simplified structure for allowing the screen and operating hot keys to be easily and quickly manufactured and assembled and for allowing the drawing figures in the screen and operating hot keys to be easily and suitably operated and touched or read by the blind people. The screen is comprised of two areas, namely Braille text section and haptic graphs section, Braille texts which are displayed in the lower portion of the screen by digit and symbol decoding circuit and some particular texts in the paragraph are displayed with haptic graphs in the upper portion of the screen through the graphic decoding circuit picking up pre-built graph database. The device is intended to serve as hardware for browsing the World Wide Web, but may be used for other computer or entertainment tasks, including creating and reading documents and for Braille reading or listening by the blind people.

2. Description of the Prior Art

Typical tactile or haptic graphic computers or portable pads for blind people comprise a screen and operating hot keys formed by a board with an array of holes filled with an electrorheological or magnetorheological fluid and a membrane fixed on the surface of the board, in which the holes are equipped with electrodes forming electrically controlled valves which connect or disconnect the cavities under the membrane with the fluid on the back of the board.

For example, U.S. Pat. No. 5,222,895 to Fricke discloses one of the typical tactile or haptic graphic computers for blind people comprising a board for forming a screen and input tablet and for being actuated or operated by the blind people, and the user is getting the information by immediately touching the membrane or by touching pins lifted by the membrane.

However, an electrorheological or magnetorheological fluid is required to be provided or disposed or filled or engaged into the array of holes of the board such that a suitable air or fluid tight seal condition is required to be formed or provided in the board to prevent the fluid from leaking from the board. In addition, the fluid may have a good chance to flow out of the board when the board is dropped onto the ground or the like.

U.S. Pat. No. 5,580,251 to Gilkes et al. discloses another typical electronic refreshable tactile display for Braille text and graphics for blind people comprising a plurality of cavities, and circuitry to individually excite the plurality of cavities, in which the plurality of cavities contain a positive and a negative electrode and are filled with a quantity of polar organic gel sensitive to electric fields.

However, a polar organic gel sensitive to electric or magnetic fields is required to be provided or disposed or filled or engaged into the plurality of cavities such that a suitable air or fluid tight seal condition is required to be formed or provide in the receptacle to prevent the fluid from leaking from the receptacle. In addition, the fluid may have a good chance to flow out of the receptacle when the receptacle is dropped onto the ground or the like.

U.S. Pat. No. 6,459,364 to Gupta discloses a further typical internet browser facility and method for the visually impaired comprising displaying a representation of a file containing hypertext links on a first portion of the matrix, and displaying a list of the hypertext links on a second portion of the matrix, and the representation may include graphical elements and text symbols such as Braille, and a mechanism including electro-magnetical actuators, electromagnetic elements, and switchable dimpled plastic film may be provided for switching the tactile elements between an inactive position in which the dot is flush with the surrounding surface, and an active position in which the dot is raised above the surrounding surface.

However, the typical mechanisms including the electro-magnetical actuators or the electromagnetic elements are also required to be filled with a polar organic gel or an electrorheological or magnetorheological fluid such that a suitable air or fluid tight seal condition is also required to be formed or provided in the fluid containing housing.

The present invention has arisen to mitigate and/or obviate the afore-described disadvantages of the conventional tactile graphic computers.

### SUMMARY OF THE INVENTION

The primary objective of the present invention is to provide a haptic graphic computer or portable pad including a screen and operating hot keys having an improved and simplified structure for allowing the screen and operating hot keys to be easily and quickly manufactured and assembled and for allowing the screen and operating hot keys to be easily and suitably operated by the blind people and for Braille reading or listening by the blind people.

In accordance with one aspect of the invention, there is provided a haptic graphic computer or portable pad comprising a processor device, a computer module connected to the processor device and including an internet processing function, and including an operating system for blind people, and including an operating program for blind people, a digit and symbol decoding circuit connected to the processor device, a digit and symbol transforming circuit and a digit driving circuit connected to the digit and symbol decoding circuit, a graph decoding circuit connected to the processor device, a graph transforming circuit and a graphic driving circuit connected to the graph decoding circuit, and a displaying device including a graphic displaying unit connected to the graphic driving circuit for displaying graphs, and including a digit displaying unit connected to the digit driving circuit for displaying digital data or information, and wherein the displaying device includes a housing having the graphic displaying unit and the digit displaying unit provided therein, and includes an electromagnetic device disposed in the housing for generating an electromagnetic field, and includes an array of guiding tubes provided in the housing, and the guiding tubes each include a guiding channel formed therein, and a movable member slidably received and engaged in the guiding channel of the guiding tube and actuatable by the electromagnetic device to partially extend out of the guiding tube and for allowing the movable member to be touched by blind people.

The guiding tubes each include a retaining element attached to an outer end of the guiding tube for limiting the movable member to slide and to move relative to the guiding tube and for allowing only a portion of the movable member 8 to be moved and extended out of the guiding tube.

A table of digits and symbols may further be provided and connected to the digit and symbol decoding circuit for providing a digit and symbol data base and information to the processor device. A graph data base may further be provided and connected to the graph decoding circuit for providing a graph data and information to the processor device.

A memory may further be provided and coupled to the processor device. The memory is selected from a read only memory (ROM) or a random access memory (RAM).

A control signal interface may further be provided and coupled between the processor device and the computer module. An information receiving buffer and an information transmitting interface may further be provided and coupled between the processor device and the computer module.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is a block diagram illustrating the parts or elements of a haptic graphic computer or portable pad in accordance with the present invention;

FIG. 2 is a top plan schematic view of the screen and operating hot keys for the haptic graphic computer; and

FIG. 3 is a partial cross sectional view of the screen and operating hot keys for the haptic graphic computer.

### DETAILED DESCRIPTION OF THE PREFERRED EMBODIMENT

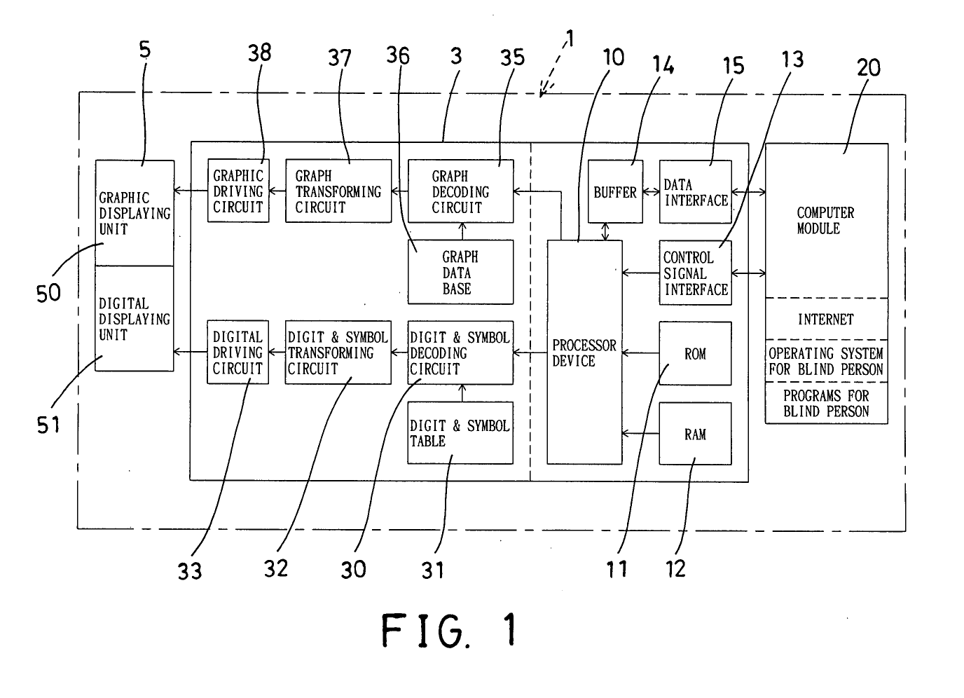

Referring to the drawings, and initially to FIG. 1, a haptic or tactile graphic computer or portable pad 1 in accordance with the present invention comprises a controller or microprocessor or processor device 10, one or more memories 11, 12, such as the read only memory (ROM) 11, the random access memory (RAM) 12, or the other memories are provided and connected or coupled to the processor device 10 for storing various data or information, a control signal interface 13 is provided and connected or coupled to the processor device 10 for signal operating or controlling purposes, a data or information receiving buffer 14 and/or a data or information transmitting interface 15 may further be provided and connected or coupled to the processor device 10 for signal or data or information receiving and/or transmitting purposes, in which the data or information transmitting interface 15 may be selected from universal serial bus (USB), RS232, Bluetooth, PCMCIA, infrared rays, matrix or arrays or the other transmitting interfaces. The device is intended to serve as hardware for browsing the World Wide Web, but may be used for other computer or entertainment tasks, including transforming and reading documents.

The haptic graphic computer 1 further includes a computer module 20 having an internet processing function, and having an operating system for blind people, and having a number of practical or operating programs for blind people, such as JAWS operating programs for blind people and for allowing the computer module 20 of the haptic graphic computer 1 to be used or operated by the blind people as the other computers for the other not blind people. The computer module 20 is connected or coupled to the processor device 10 directly or indirectly with the control signal interface 13 and/or data or information receiving buffer 14 and/or the data or information transmitting interface 15 for suitably connecting or coupling to or communicating with the processor device 10 and for allowing the processor device 10 to process or operate various internet operating systems, practical or operating programs or the like.

The haptic graphic computer 1 further includes a digit and symbol decoding circuit 30 connected or coupled to the processor device 10, and a table or data or information or data base of digits and symbols 31 provided and connected or coupled to the digit and symbol decoding circuit 30 for providing the digit and symbol data base or information to the processor device 10, and a digit and symbol transforming circuit 32 and a digit driving circuit 33 connected or coupled in series to the digit and symbol decoding circuit 30 and for allowing the processor device 10 to process or operate or output various digits and symbols. The haptic graphic computer 1 further includes a graph decoding circuit 35 connected or coupled to the processor device 10, and a table or data or information or data base of graphs 36 provided and connected or coupled to the graph decoding circuit 35 for providing the graph data base or information to the processor device 10, and a graph transforming circuit 37 and a graphic driving circuit 38 connected or coupled in series to the graph decoding circuit 35 and for allowing the processor device 10 to process or operate or output various graphs or graphical data or information or signals.

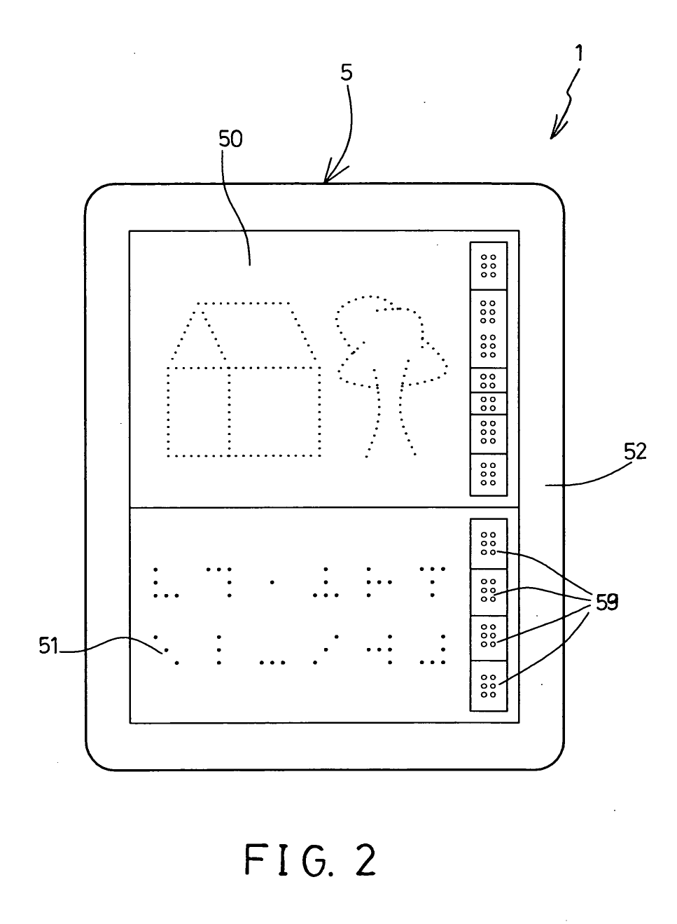

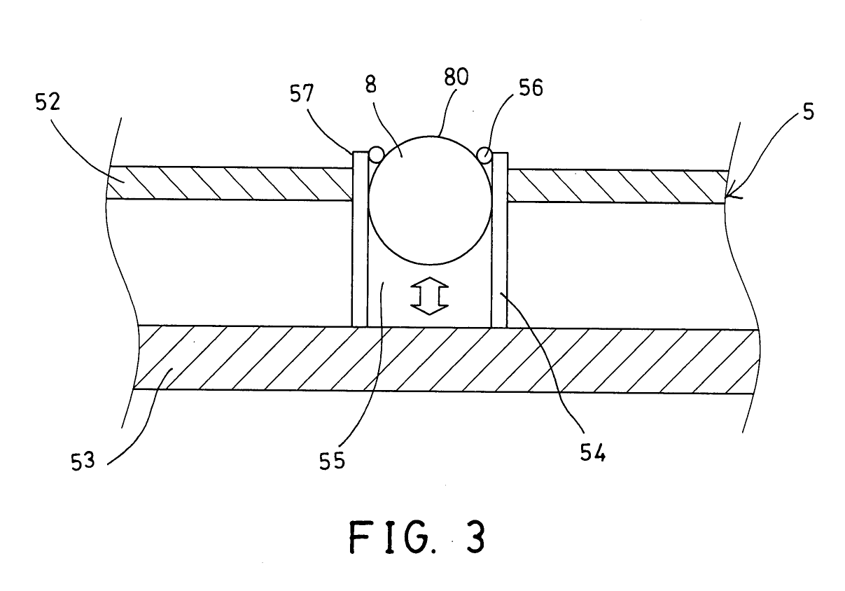

The haptic graphic computer 1 further includes a displaying device 5 having a graphic displaying unit 50 connected or coupled to the graphic driving circuit 38 and/or the graph transforming circuit 37 and/or the graph decoding circuit 35 for showing or displaying the graphs or graphical data or information or signals, and having a digit displaying unit 51 connected or coupled to the digit driving circuit 33 and/or the digit and symbol transforming circuit 32 and/or the digit and symbol decoding circuit 30 for showing or displaying the digits or digital data or information or signals. For example, as shown in FIGS. 2 and 3, the displaying device 5 includes a pad or board or housing 52 having the graphic displaying unit 50 and the digit displaying unit 51 formed or provided therein, and includes an electromagnetic device 53 disposed or attached or mounted or engaged in the housing 52 for forming or generating an electromagnetic field.

The displaying device 5 further includes a matrix or series or array of guiding tubes 54 formed or provided therein, and the guiding tubes 54 each include a chamber or guiding channel 55 formed or provided therein for slidably receiving or engaging with a touchable element or follower or sliding or movable member 8, and an anchoring or retaining ring or element 56 attached or mounted or secured to the upper or outer end 57 of each guiding tube 54 for guiding or limiting the movable member 8 to slide or to move along or relative to the guiding tube 54 and for allowing only a portion 80 of the movable member 8 to be moved or extended out of the guiding tube 54, or for allowing the movable member 8 to partially move or extend out of the guiding tube 54, and thus for allowing the outer portion 80 of the movable member 8 to be touched by the blind people, in which the electromagnetic device 53 may actuate or operate the movable members 8 to have the outer portions 80 of some or several or all of the movable members 8 to be moved or extended out of the guiding tube 54 and to form the required digits or symbols or haptic graphs that are controlled or actuated or operated by the digit driving circuit 33 and the graphic driving circuit 38. The displaying device 5 may further include a number of haptic hot keys 59 for operating the displaying device 5.

It is to be noted that the movable members 8 may be easily and suitably controlled or actuated or operated by the electromagnetic device 53 to show or to display the required digits or symbols or graphs and for Braille reading or listening by the blind people, without the electrorheological or magnetorheological fluid, such that the pad or housing 52 is not required to be formed with a suitable air or fluid tight seal condition and such that no fluid leaking problem will be occurred in the pad or housing 52.

Accordingly, the haptic graphic computer or portable pad in accordance with the present invention includes a screen and operating hot keys having an improved and simplified structure for allowing the screen and operating hot keys to be easily and quickly manufactured and assembled and for allowing the screen and operating hot keys to be easily and suitably operated by the blind people.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A haptic graphic computer comprising:
a processor device,
a computer module connected to said processor device and including an internet processing function, and including an operating system for blind people, and including an operating program for blind people,
a digit and symbol decoding circuit connected to said processor device,
a digit and symbol transforming circuit and a digit driving circuit connected to said digit and symbol decoding circuit,
a graph decoding circuit connected to said processor device,
a graph transforming circuit and a graphic driving circuit connected to said graph decoding circuit, and
a displaying device including a graphic displaying unit connected to said graphic driving circuit for displaying graphs, and including a digit displaying unit connected to said digit driving circuit for displaying digital data or information, and
wherein said displaying device includes a housing having said graphic displaying unit and said digit displaying unit provided therein, and includes an electromagnetic device disposed in said housing for generating an electromagnetic field, and includes an array of guiding tubes provided in said housing, and said guiding tubes each include a guiding channel formed therein, and a movable member slidably received and engaged in said guiding channel of said guiding tube and actuatable by said electromagnetic device to partially extend out of said guiding tube and for allowing said movable member to be touched by blind people.

2. The haptic graphic computer as claimed in claim 1, wherein said guiding tubes each include a retaining element attached to an outer end of said guiding tube for limiting said movable member to slide and to move relative to said guiding tube and for allowing only a portion of said movable member 8 to be moved and extended out of said guiding tube.

3. The haptic graphic computer as claimed in claim 1 further comprising a table of digits and symbols connected to said digit and symbol decoding circuit for providing a digit and symbol data base and information to said processor device.

4. The haptic graphic computer as claimed in claim 1 further comprising a graph data base connected to said graph decoding circuit for providing a graph data and information to said processor device.

5. The haptic graphic computer as claimed in claim 1 further comprising a memory coupled to said processor device.

6. The haptic graphic computer as claimed in claim 5, wherein said memory is selected from a read only memory (ROM) or a random access memory (RAM).

7. The haptic graphic computer as claimed in claim 1 further comprising a control signal interface coupled between said processor device and said computer module.

8. The haptic graphic computer as claimed in claim 1 further comprising an information receiving buffer and an information transmitting interface coupled between said processor device and said computer module.
